(19) United States
(12) Patent Application Publication
(10) Pub. No.: US 2023/0125750 A1
(43) Pub. Date: Apr. 27, 2023

(54) PROCESS FOR TREATING A CARBON DIOXIDE-RICH GAS CONTAINING WATER

(71) Applicant: L'Air Liquide Societé Anonyme pour l'Etude et l'Eploitation des Procédés Georges Claude, Paris (FR)

(72) Inventors: Marine ANDRICH, Jouy-en-Josas (FR); Gian Luigi CALORO, Verneuil l'Etang (FR)

(21) Appl. No.: 17/970,871

(22) Filed: Oct. 21, 2022

(30) Foreign Application Priority Data
Oct. 21, 2021 (FR) 2111205

(51) Int. Cl. B01D 53/26; B01D 53/14; B01D 53/78; F25J 3/06

(52) U.S. Cl. CPC B01D 53/265; B01D 53/1493; B01D 53/261; B01D 53/1418; B01D 53/78; B01D 53/1456; F25J 3/067; B01D 2252/103

(57) ABSTRACT

In a process for treating a carbon dioxide-rich gas (1) containing water, the treatment by compression and/or washing and/or drying of the gas produces acidified water (W1, W2, W3, W4, W7) which is sent to a cooling circuit (W8, W10).

### CROSS REFERENCE TO RELATED APPLICATIONS

This application claims the benefit of priority under 35 U.S.C. § 119 (a) and (b) to French Patent Application No. 2111205, filed Oct. 21, 2021, the entire contents of which are incorporated herein by reference.

### BACKGROUND

The present invention relates to a process for treating a carbon dioxide-rich gas containing water. The gas may contain at least one acid gas other than carbon dioxide.

The carbon dioxide-rich gas contains at least 10 mol % of carbon dioxide or at least 50 mol % of carbon dioxide, or even at least 80 mol % of carbon dioxide. The flue gases from the burners of a steam methane reformer (known under the acronym SMR) produce a gas containing 10 mol % of CO₂ and also approximately 70% of nitrogen.

The invention applies to the treatment, for example the compression, washing, cooling or drying, of any carbon dioxide-rich gas optionally containing at least one other acid gas, such as NO, NO₂, SO₂ or SO₃.

The gas may be derived from a combustion, for example an oxycombustion, from fermentation, from a PSA for removal of hydrogen, from a steelworks, from a cement works, or from the production of ammonia, lime or ethylene oxide.

It may be natural gas or biomethane also containing methane in both cases.

U.S. Pat. No. 4,542,114 describes the removal of the other acid gases present in a carbon dioxide-rich gas by compression, the acid gases being concentrated in the water condensates produced during the compression. The acidified water formed is not used.

“Industrial Gases Processing”, by Häring, published by Wiley VCH 2008, describes the delivery of water condensed in a compressor of carbon dioxide-rich gas as waste (“waste water system”). This inevitably has the result of delivering acid into the sewers, which is dangerous to the environment.

US2002/0144506 describes the condensation of water in carbon dioxide compressed in a compressor after cooling, the water then being sent to combustion.

Hydrogen is an energy carrier that plays an increasing role in decarbonization in various sectors, in particular transport and industry, Hydrogen can be produced from the reforming reaction of natural gas (in SMR [Steam Methane Reforming] furnaces) or by electrolysis of water, Electrolysis of water has the advantage of not producing greenhouse gases but consumes a lot of electricity (decarbonized if possible). In SMRs, hydrogen production is accompanied by significant CO₂ production. A CO₂ capture unit can be added to an SMR in order to reduce the carbon footprint of the production of hydrogen by SMR. CO₂ capture (ag. CO₂ treatment and liquefaction for food use or for sequestration) can be carried out cryogenically or non-cryogenically (for example, amine scrubbing).

The CO₂ produced during combustion (by treatment of gas from combustion in air or in oxygen) contains some NOₓ. The reaction for oxidation of NO to NO₂ is slow, whereas the other reactions, and in particular the reactions for hydrolysis of NO₂ and N₂O₃ in the presence of water, are rapid and equilibrated:

2NO+O2⇔2NO₂

3NO₂+H₂O⇔2HNO₃+NO

NO+NO₂⇔N₂O₃

N₂O₃+H₂O⇔2HNO₂

Thus, when the CO₂ contains water and NOₓ, acid condensates are formed in the process due to the formation of HNO₃ and HNO₂ in the water condensed (for example partial condensation between two stages of compression of wet CO₂, partial condensation of the TSA dryer regeneration product, condensates from the water washing tower in the case where the pH has not gone back up too high to reduce the SOₓ).

Moreover, even in the case where the carbon dioxide-rich gas does not contain any other acid gas (therefore no NOₓ), the washing of this gas with water and the cooling or drying of said gas can produce acidified water.

In addition, a cooling water network is generally used on the CO₂-rich gas treatment unit in order to cool the compressed fluid at the outlet of the compression stages and upstream of the dryer. This water has a tendency gradually to fur up heat exchangers, making them less effective. The furring up of water exchangers can be limited by maintaining an acid pH (pH<7) in the cooling water. A water treatment unit or an injection of an acid (e.g. H₂SO₄) makes it possible to maintain the acid pH of the water and to limit the furring up. Depending on the circumstance, in particular depending on the hardness of the water, a higher pH may be desired, for example a pH<8.5 or <8.

### SUMMARY

According to one subject of the invention, a process is provided for treating a carbon dioxide-rich gas containing water and optionally at least one other acid gas, wherein:

a) the gas is compressed in at least one compression stage and cooled and at least one condensate is separated from the cooled gas after at least one compression stage, preferably between two compression stages, the condensate consisting of water in which the CO₂ and/or the at least one other acid gas is dissolved, forming acidified water having a pH of at most 6.5, and/or

b) the carbon dioxide-rich gas is purified, optionally upstream of the compression of step a), in a unit for washing with water so as to produce a purified gas optionally to be sent for compression and water containing impurities, and/or

c) the gas, optionally compressed in step a), is dried in a drying unit and water contained in the compressed gas is recovered, forming recovered water, wherein:

i) at least a portion of the acidified water of step a) and/or

ii) at least a portion of the water containing impurities of step b) and/or

iii) at least a portion of the recovered water of step c)

is/are mixed with water circulating in a cooling circuit so as to form a mixture with a desired degree of acidity, preferably having a pH of less than 8.5, or even less than 7, preferably greater than −2.

According to other optional aspects:
the mixture serves to cool an indirect-contact heat exchanger;
the heat exchanger is of brazed aluminum plate-fin type or corrugated plate type or shell-and-tube type;
the heat exchanger serves to cool carbon dioxide-rich gas compressed in step a), downstream of at least one compression stage, and/or to be purified in step c);
the dryer operates by water adsorption and is periodically regenerated by a dry regeneration gas which leaves the adsorption unit having recovered therein water accumulated in the drying unit;
the heat exchanger serves to cool the regeneration gas having recovered the water in the drying unit, the water thus condensed constituting the recovered water of step c);
the dryer dries the gas by compressing it and/or by cooling it so as to condense the water that it contains;
the desired degree of acidity is greater than a pH of 1 or greater than a pH of 3;
the at least one other acid gas is chosen from the group: SO₂, SO₃, H₂S, HCl, NO, N₂O, NO₂, N₂O₄, HNO₃, HNO₂, H₂CO₃;
an acid flow originating from storage is added to the water of the cooling circuit;
the flow of water from the flow or flows i) and/or ii) and/or iii) is adjusted so as to obtain a desired pH in the cooling circuit;
at least one flow i), ii) or iii) having a first pH is mixed with another of these three flows having a second pH different from the first pH;
the acid flow originating from storage and also at least one of the flows i) and/or ii) and/or iii) is adjusted so as to obtain a desired pH in the cooling circuit;
the at least one of the flows i) and/or ii) and/or iii) has a first pH different from that of the acid flow;
the at least one of the flows i) and/or ii) and/or iii) has a first pH higher than that of the acid flow;
the at least one of the flows i) and/or ii) and/or iii) has a first pH lower than that of the acid flow;
the carbon dioxide-rich gas is purified upstream of the compression in the unit for washing with water so as to produce a purified gas and water containing impurities, and the temperature and/or flow rate of washing water sent to the cooling tower is/are adjusted in order to vary the flow rate and/or the acidity of the water containing impurities sent to the cooling circuit;
the cooling circuit serves to cool a gas compressed in a compression stage, which may be that of step a) or a stage for compression of a gas produced by treating a gas treated in at least one of steps a) and/or b) and/or c);
the addition of the water i) and/or ii) and/or iii) can increase or reduce the degree of acidity of the water circulating in the cooling circuit;
the cooling circuit contains cooling water having a pH between 6 and 8, or even between 6.5 and 7.5, before being mixed with the at least one of the flows i), ii) or iii).

According to another subject of the invention, a device is provided for treating a carbon dioxide-rich gas containing water and optionally at least one other acid gas, comprising:

a) at least one compression stage for compressing the gas, cooling means for cooling the compressed gas and at least partially condensing the water that it contains, and means for separating at least one condensate of the cooled gas, the separating means being placed after at least one compression stage, preferably between two compression stages, the condensate consisting of water in which the CO₂ and/or the at least one other acid gas is dissolved, forming acidified water having a pH of at most 6.5, and/or

b) a unit for washing with water so as to produce a purified gas, optionally to be sent for compression, and water containing impurities, and/or

c) a drying unit and also means for recovering the water removed by the drying,

which comprises means for mixing:

i) at least a portion of the acidified water of option a) and/or

ii) at least a portion of the water containing impurities of option b) and/or

iii) at least a portion of the recovered water of option c)

with water circulating in a cooling circuit so as to form a mixture with a desired degree of acidity, preferably having a pH of less than 8.5, or even less than 7, preferably greater than −2.

According to other optional features, the device comprises:
means for sending the mixture to cool an indirect-contact heat exchanger;
the heat exchanger is of aluminum brazed plate-fin type or corrugated plate type or shell-and-tube type;
the heat exchanger is arranged so as to cool carbon dioxide-rich gas compressed in step a), downstream of at least one compression stage, and/or to be purified in step c);
the dryer comprises several water adsorption beds and also means for periodically sending a dry regeneration gas to one of the beds and means for removing from the bed the regeneration gas having recovered water accumulated in the drying unit.
the heat exchanger is arranged to cool the regeneration gas having recovered the water in the drying unit, the water thus condensed constituting the recovered water of step c);
the dryer comprises compression and/or cooling means so as to condense the water contained in the gas to be dried;
means for adding an acid flow originating from storage to the water of the cooling circuit;
a container for storing an acid, connected to the cooling circuit;
means for adjusting the flow of water from the flow or flows i) and/or ii) and/or iii) in order to obtain a desired pH in the cooling circuit;
means for mixing at least one flow i), ii) or iii) having a first pH with another of these three flows having a second pH different from the first pH;
means for adjusting the acid flow originating from storage and also at least one of the flows i) and/or ii) and/or iii) so as to obtain a desired pH in the cooling circuit;
means for sending the carbon dioxide-rich gas to be purified, optionally upstream of the compression, to the unit for washing with water so as to produce a purified gas and water containing impurities;
means for adjusting the temperature of the washing water sent to the cooling tower in order to vary the flow rate and/or the acidity of the water containing impurities that is sent to the cooling circuit;
means for adjusting the flow rate of the washing water sent to the cooling tower in order to vary the flow rate and/or the acidity of the water containing impurities that is sent to the cooling circuit;
the cooling circuit is arranged to cool a gas compressed in a compression stage, which may be that of step a) or a stage for compression of a gas produced by treating a gas treated in at least one of steps a) and/or b) and/or c).

The present invention consists in injecting at least one portion of the acid condensates generated by a process for treating the gas rich in CO₂ and optionally comprising HNO₃ or HNO₂ in the cooling water network in order to maintain a pH of less than 8.5, or even less than 8, or even less than 7, instead of or in addition to injecting H₂SO₄ or another acid into the water network. This makes it possible to limit the consumption of acid to be injected and/or to reduce the investment and/or operational cost for the cooling water treatment unit.

Thus, one solution according to the invention is to inject the acidified water condensed downstream of at least one intermediate cooler and/or of the final cooler of a compressor of a carbon dioxide-rich gas into a cooling water network rather than into the tower for washing with water or the limiting battery of the client.

In many cases, the gas compressed in the compressor is then dried in a dryer comprising several adsorption beds which must regularly be regenerated in order to remove the water that has accumulated therein. The regeneration gas sent to the dryer leaves the latter having become loaded with water vapor. Once this vapor has been condensed, the water produced can also be sent to a water cooling circuit.

Preferably, the regeneration gas, generally taken from a separation unit downstream of the dryer, can be mixed with the gas originating from an intermediate or final stage of the compressor, so that the condensed water is a mixture of water present at the inlet of the compressor and of water originating from the regeneration gas.

Alternatively, the drying of the gas can be carried out simply by cooling the carbon dioxide-rich gas so as to condense the water, it being possible for the recovered water to be sent to the cooling circuit.

The cooling water circuit can also be supplied with water condensed in the tower for washing with water upstream of the compressor (if present). This water will be acidified due to the presence of acid gases in the gas to be washed. A portion of the NOx and/or SOx that the carbon dioxide-rich gas contains will be removed in the tower by washing with water, and the water accumulating in the tower tank contains the acids dissolved in the washing water.

It will thus be understood that the acidity of the water of the cooling circuit can be adjusted by adding thereto water from at least one source, it being possible for the water to originate from the tower for cooling the CO₂-rich gas and/or from the compression of the CO₂-rich gas and/or from the dryer, for example from the regeneration gas from the dryer of the compressed CO₂-rich gas.

These water sources can have different acidity levels and it therefore becomes possible, by metering the amount of water sent from one or more potential sources, to adjust the level of acidity in the cooling water circuit.

The alternative solution would be to add acid (for example sulfuric acid) to the water circuit in order to prevent the formation of limescale in the circuits, this solution requiring an acid to be supplied and stored on site.

However, the present invention can in some cases avoid having to manage an acid source from outside the site, while at the same time solving the economic and especially environmental problem of the management of acid waste.

The present invention can also be applied to the use of condensates from the purge of the tower for washing with water upstream of the compression, for example in the cooling water network of the unit if the composition and the pH of the condensates allow it; if the tower for washing with water or another dedicated column also makes it possible to reduce the SOx, then depending on the amount of ions accumulated in the purge in the event of reduction of the SOx with the addition of sodium hydroxide or another basic solution, the purge water obtained will be basic. In this case, the purge water could be added to the water of the refrigeration circuit so as to make it more basic or so as to correct excessive acidity.

The refrigeration circuit preferably serves to cool a gas at the outlet of a compression stage of a compressor, which may be a compressor of the carbon dioxide-rich gas or a compressor of a product from a device for separating the carbon dioxide-rich gas, located for example downstream of the dryer (if present) and/or downstream of the compressor of the carbon dioxide-rich gas, if present.

### BRIEF DESCRIPTION OF THE FIGURE

For a further understanding of the nature and objects for the present invention, reference should be made to the following detailed description, taken in conjunction with the accompanying drawings, in which like elements are given the same or analogous reference numbers and wherein:

FIG. 1 illustrates a process according to the invention.

### DETAILED DESCRIPTION OF PREFERRED EMBODIMENTS

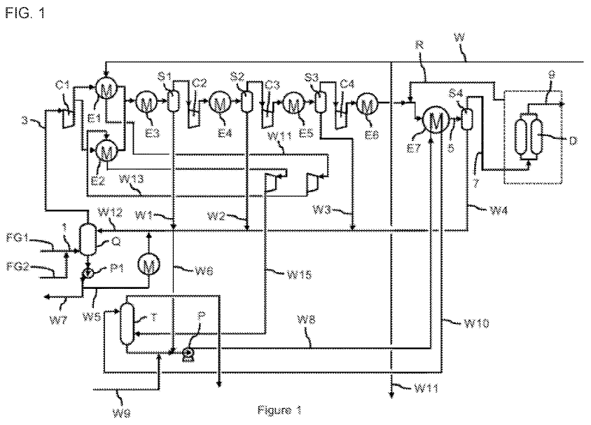

In FIG. 1, the carbon dioxide-rich gas can originate from any source capable of producing such a gas. Here, two combustion gas flows FG1 and FG2 are mixed so as to form the carbon dioxide-rich gas 1 containing for example at least 10 mol % of CO₂, at least 40 mol % of CO₂, at least 80 mol % of CO₂ or at least 90 mol % of CO₂. This gas is sent to a tower for washing with water Q supplied at the top by pressurized water, W12, capable of absorbing at least one acid gas present in the carbon dioxide-rich gas, for example SO₂, SO₃, NO₂, NO, N₂O, HNO₃, HNO₂, CO₂, etc. The washing tower Q can also operate at atmospheric pressure or sub-atmospheric pressure. The flow rate of water W12 sent to the top of the tower can be varied in order to adjust the flow rate and/or the acidity of liquid formed in the tank of the tower Q.

The water in the tank of the tower Q is acidified and can be pumped by a pump P1. A portion W5 is optionally mixed with the water W12 and the remainder W7 can be sent according to the invention to the cooling circuit in order to vary the acidity level thereof (not shown in the FIGURE).

The carbon dioxide-rich gas 3 purified in the tower Q is, in this example, compressed in a compressor C1, then divided into two and cooled in two heat exchangers E1, E2 by indirect heat exchange with different nitrogen flows W13 or with another refrigerant, such as water. Next, the gas flows are combined and cooled in the heat exchanger E3 in order to condense a portion of the water contained in the gas. This water will contain carbonic acid in a dissolved form and/or sulfuric acid and/or sulfurous acid and/or nitric acid, and/or nitrous acid. It is separated from the gas in a separator S1 or by another equivalent means, the condensate W1 of which is drawn off into the separator tank S1. The gas is again compressed, in a compressor C2, and cooled in a heat exchanger E4 and the water formed is separated in a phase separator S2 or another equivalent means, the condensate W2 of which is drawn off into a tank. The gas from the separator S2 is again compressed, in a compressor C3, and cooled in a heat exchanger E5 and the water formed is separated in a phase separator S3, the condensate W3 of which is drawn off into a tank. The gas from the separator S3 or another equivalent means is compressed by a compressor C4, is cooled by a heat exchanger E6 and then in an exchanger E7 in order to further condense water. This water in the gas 5 is removed in the separator S4 or another equivalent means in order to form a gas 7 and condensed water W4.

The gas 7 is then dried in a dryer D which may be an adsorption unit. The dried gas 9 may then be used as dry product or be purified by another means such as another adsorption unit and/or a membrane and/or a unit for separation at a temperature below 0° C., for example by partial condensation and/or distillation.

If the dryer D operates by adsorption, it will be necessary to regenerate it by sending thereto a dry regeneration gas. This gas R leaves the dryer loaded with water and can be mixed with the flow 5, in this case between the exchangers E6, E7, the mixing point depending on the amount of water contained and on the temperature of the gas R. It goes without saying that the composition of the gas R must be compatible with the definitive use of the gas 9. It may for example be rich in carbon dioxide.

It will be understood that the dryer does not necessarily operate via adsorption. The gas 7 may simply be cooled and/or pressurized in order to condense the water that it contains, this acidified water being recovered as flow R for supplying the cooling cycle.

The water flows W1, W2, W3, W4 are mixed so as to form a flow of water containing at least one dissolved acid gas. The mixture formed may nevertheless only contain at least two of the flows mixed together. Alternatively, just one flow W1, W2, W3, W4 can be recovered. At least one portion of the recovered water (mixed or not mixed) is sent to the water of a refrigeration cycle.

In the case of the example, the water is sent as flow W6 to the heat exchanger E7, where the gas 5 cools downstream of the exchanger E6, in this case mixed with the regeneration gas R.

Thus, the water recovered in S4 comes partially from the regeneration gas R.

Here, the water W6 is not cooled upstream of the exchanger E7. Nevertheless, it is possible to cool it, for instance in the cooling tower T.

The possibility of varying a flow sent to join the water circuit and/or mixing at least two flows makes it possible to compensate for acidity levels that are too high or too low.

For example, if one of the flows W1 to W4 or W7 has an exceptionally high acidity level, it can nevertheless serve to supply the cooling cycle, by reducing its flow rate and/or by mixing it with a less acid flow.

A nitrogen circuit W serves to cool the exchanger E1 and the exchanger E2, optionally after expansion in a turbine. The nitrogen expanded in the turbine supplies a tower T by the bottom. While rising up the tower, it cools the water W10 sent to the top of the tower, producing a reheated nitrogen flow at the top of the tower, which is discharged into the atmosphere, and cooled water in a tank which supplies the cooling circuit. A nitrogen flow W11 can be sent into the atmosphere. For example, if the nitrogen W arrives too cold or if there is no need to cool very much the flow of water W10 depending on how much heat is introduced by the heat exchanger E7 into the cooling circuit, not all the nitrogen is sent to the tower T, but the portion W11 can be sent directly into the atmosphere. This constitutes a way to adjust the temperature of the water W8 originating from the tower T.

It will be understood that the precise type of nitrogen circuit is not important and, for this reason, it is not described in detail.

It should be noted that the cooling water circuit is optionally supplied with an acid flow W9, which may be sulfuric acid and/or may have a pH of less than 7.

This sending of acid can be eliminated or reduced since the water circuit is acidified by water originating from at least one of three sources, namely;
the washing tower Q, when present, the condensate W7 of which can be mixed with the water circuit;
the regeneration gas R, when present, the water of which can optionally be separated by mixing it with the gas to be dried;
at least one of the compression stages C1, C2, C3, C4 after cooling and partial condensation.

It should be noted that the compressors C1, C2, C3, C4 can each consist of at least one stage of a compressor.

The tower Q can be supplied with water originating from at least one of the compressors C1 to C4 so as to form the flow W12. This flow W12 may otherwise be completely independent.

It is possible to adjust the flow rate and/or the acidity of the flow W12 by varying the flow rate and/or the acidity of the flow W12. The flow rate can be varied by means of a valve on the flow W12. Alternatively, at least one of the flows W1, W2, W3 can be adjusted by means of a valve Since the flows W1, W2, W3 may have different acidity levels, this may be sufficient to vary the acidity of the purge of water removed in the column tank.

The water having served to cool the heat exchanger E7 can be sent to a washing tower T at the top thereof, so as to cool a nitrogen flow W15.

The acid W9, if present, is preferably mixed with the liquid from the tank of the tower T and then the water formed is mixed with the flow W6.

The water in the gas R is astutely recovered by mixing the gas R with the gas compressed between the exchangers E6 and E7, so that the exchanger E7 cools the gas R and the separator S4 recovers the water originating from the compressor and from the regeneration gas R.

The cooling cycle supplied with the water from at least one of the sources a), b), c) may be that of the compressor of the source a) or any other compressor, for example a compressor of product from a separation device supplied with the carbon dioxide-rich gas.

In the example of the FIGURE, water is taken from the washing tower, the washed gas compressor and the dryer of the gas originating from the compressor in order to supply the cooling circuit.

Nevertheless, it will be understood that the washing tower, the compressor and the dryer are not necessarily all present.

For example, the process may be solely a washing process (and the device a washing tower with associated means) producing acidified water for acidifying water from a cooling circuit. In this case, the compressor and/or the dryer is not present. The washing tower can therefore produce a gas to be treated by compression and/or drying.

Likewise, the process may be solely a drying process (and the device a dryer with associated means) producing acidified water for acidifying water from a cooling circuit. In this case, the compressor and/or the washing tower is not present, Therefore, the dryer can dry a gas originating from the compression of the gas to be dried and/or from the washing in a washing tower, so as to produce the gas to be treated by drying.

The cooling circuit may cool gas from a compression stage, which may be the gas that has been purified in the washing tower and/or gas to be dried in the dryer, Otherwise, it may cool a cooling circuit independent of steps a), b) and c).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for treating a carbon dioxide-rich gas containing water and at least one other acid gas, comprising:
a) compressing the gas in at least one compression stage and cooling the compressed gas and separating at least one condensate from the cooled gas after at least one compression stage, the condensate consisting of water in which the CO₂ and/or the at least one other acid gas is dissolved, forming acidified water having a pH of at most 6.5, and/or
b) purifying the carbon dioxide-rich gas, upstream of the compression of step a), in a unit for washing with water so as to produce a purified gas and water containing impurities, and/or
c) drying the gas compressed in step a), in a drying unit and recovering the water contained in the compressed gas, forming recovered water,
wherein:
i) at least a portion of the acidified water of step a) and/or
ii) at least a portion of the water containing impurities of step b) and/or
iii) at least a portion of the recovered water of step c)
is/are mixed with water circulating in a cooling circuit thereby forming a mixture with a desired degree of acidity.

2. The process as claimed in claim 1, wherein the mixture serves to cool an indirect-contact heat exchanger.

3. The process as claimed in claim 2, wherein the heat exchanger is of aluminum brazed plate-fin type or corrugated plate type or shell-and-tube type.

4. The process as claimed in claim 2, wherein the heat exchanger serves to cool carbon dioxide-rich gas compressed in step c), downstream of at least one compression stage, and/or to be purified in step c).

5. The process as claimed in claim 2, wherein the dryer operates by water adsorption and is periodically regenerated by a dry regeneration gas which leaves the adsorption unit having recovered therein water accumulated in the drying unit.

6. The process as claimed in claim 2, wherein the heat exchanger serves to cool the regeneration gas having recovered the water in the drying unit, the water thus condensed constituting the recovered water of step c).

7. The process as claimed in claim 1, wherein the at least one other gas is chosen from the group: SO₂, SO₃, H₂S, HCl, NO, N₂O, NO₂, N₂O₄, HNO₃, HNO₂, H₂CO₃.

8. The process as claimed in claim 1, wherein an acid flow originating from storage is added to the water of the cooling circuit.

9. The process as claimed in claim 1, wherein the flow of water from the flow or flows i) and/or ii) and/or iii) is adjusted so as to obtain a desired pH in the cooling circuit.

10. The process as claimed in claim 8, wherein the acid flow originating from storage and also at least one of the flows i) and/or ii) and/or iii) is adjusted so as to obtain a desired pH in the cooling circuit.

11. The process as claimed in claim 1, wherein the carbon dioxide-rich gas is purified upstream of the compression in the unit for washing with water so as to produce a purified gas and water containing impurities; and the temperature and/or flow rate of washing water sent to the cooling tower is/are adjusted in order to vary the flow rate and/or the acidity of the water containing impurities sent to the cooling circuit.

12. The process as claimed in claim 1, wherein the cooling circuit serves to cool a gas compressed in a compression stage, which may be that of step a) or a stage for compression of a gas produced by treating a gas treated in at least one of steps a) and/or b) and/or c).

13. A process for treating a carbon dioxide-rich gas containing water and at least one other acid gas; comprising:
a) at least one compression stage, for compressing the gas, cooling means for cooling the compressed gas and at least partially condensing the water that it contains, and means for separating at least one condensate of the cooled gas, the separating means being placed after at least one compression stage, the condensate consisting of water in which the CO₂ and/or the at least one other acid gas is dissolved, forming acidified water having a pH of at most 6.5, and/or
b) a unit for washing with water so as to produce a purified gas, and water containing impurities, and/or
c) a drying unit and also means for recovering the water removed by the drying,
which comprises means for mixing:
i) at least a portion of the acidified water of option a) and/or
ii) at least a portion of the water containing impurities of option b) and/or
iii) at least a portion of the recovered water of option c)
with water circulating in a cooling circuit so as to form a mixture with a desired degree of acidity.
